(19) United States
(12) Patent Application Publication
(10) Pub. No.: US 2023/0388897 A1
(43) Pub. Date: Nov. 30, 2023

(54) GEOSPATIAL BASED RESTRICTION OF FIXED WIRELESS ACCESS (FWA)

(71) Applicant: T-Mobile USA, Inc., Bellevue, WA (US)

(72) Inventor: Roopesh Kumar Polaganga, Bothell, WA (US)

(21) Appl. No.: 17/752,637

(22) Filed: May 24, 2022

(51) Int. Cl. H04W 48/02; H04W 64/00; H04W 28/20

(52) U.S. Cl. CPC H04W 48/02; H04W 64/003; H04W 28/20

(57) ABSTRACT

Systems, methods, and devices that relate to restricting communication for Fixed Wireless Access (FWA) devices based on the geospatial locations are disclosed. In one example aspect, a method for wireless communication includes receiving, by a first base station, location information indicating a current position of a fixed wireless access (FWA) device, and determining, by the first base station, that the FWA device is located in a region that is outside of a designated region configured for the FWA device based on the current position of the FWA device. The method also includes restricting, by the first base station, a network communication for the FWA device in the region based on the determining.

### BACKGROUND

Mobile communication technologies are moving the world toward an increasingly connected and networked society. With the use of advance wireless communication techniques, mobile technology starts to intersect with the demands of fixed line services.

### BRIEF DESCRIPTION OF THE DRAWINGS

FIG. 1 illustrates an example Fixed Wireless Access (FWA) configuration in accordance with one or more embodiments of the present technology.

FIG. 2 is a flowchart representation of a process for wireless communication in accordance with one or more embodiments of the present technology.

FIG. 3 is a flowchart representation of another process for wireless communication in accordance with one or more embodiments of the present technology.

FIG. 4 illustrates an example of intra-cell FWA mobility in accordance with one or more embodiments of the present technology.

FIG. 5 illustrates another example of intra-cell FWA mobility in accordance with one or more embodiments of the present technology.

FIG. 6 illustrates an example core network architecture in accordance with one or more embodiments of the present technology.

FIG. 7 illustrates an example of inter-cell FWA mobility in accordance with one or more embodiments of the present technology.

FIG. 8 is a diagram that illustrates a wireless telecommunication network in which aspects of the disclosed technology are incorporated.

FIG. 9 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Techniques related to restricting communications for Fixed Wireless Access (FWA) devices based on the geospatial locations are disclosed. In particular, when a current position of a FWA device moves outside of a designated region that is configured for the FWA, a network communication for the FWA device in the region can be rejected or be limited to enable a balanced use of network resources for different users. The disclosed techniques can also provide more accurate network planning for future uses.

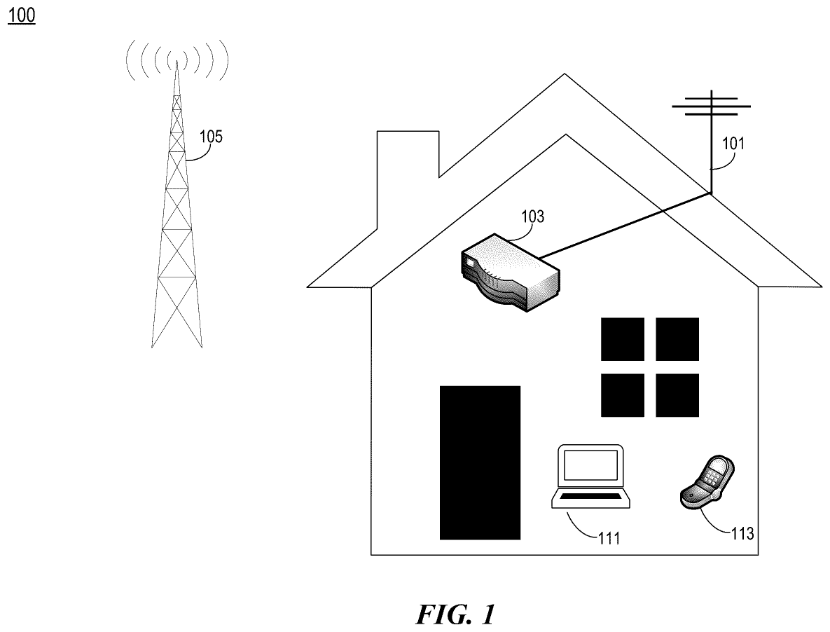

The advent of 5G wireless communication technology allows the mobile technology to intersect with the demands of fixed line services. As compared to wired connections, FWA is an efficient and scalable alternative, enabling network operators to deliver ultra-high-speed broadband to suburban and rural areas so as to home and business applications where fiber is prohibitively expensive to lay and maintain. FIG. 1 illustrates an example FWA configuration 100 in accordance with one or more embodiments of the present technology. Customers who registered for FWA services are provided with FWA devices, such as antennas 101 and/or routers 103 that are capable of communicating with the closest base stations 105, to obtain ultra-high-speed connections in residential homes or businesses. User devices, such as laptops 111 and mobile phone 113, are connected to the network via the router 103. The FWA devices (e.g., routers) are expected to have minimal to no mobility because they are deployed as fixed assets in homes or businesses. The usage pattern of FWA devices follows a similar cycle as other types of devices (e.g., peak usage occurs during the day while usage past midnight drops). However, because there are multiple devices connected to a FW device, the average usage from a FWA device is expected to be higher as compared to individual user devices such as cell phones and/or tablets.

Because the usage from the FWA devices is expected to be higher, network carriers have taken a staged approach for FWA services by providing the service in only selected areas based on the network capacity and network utilization. In wireless communications, geospatial data or location information can be visualized by binning in hexagonal patterns. Each hex-bin can be uniquely identified by its radius and/or central latitude/longitude location. The location information received from the FWA devices and/or user devices can be used to identify a unique hex bin in that coverage area. Each hex-bin can have its own metrics based on cell trace, Per Call Measurement Data (PCMD) and/or User Equipment (UE) based reporting. In some embodiments, the selected areas/regions can be represented as hex-bins.

It has been observed that customers may move the FWA devices outside of the designated areas/regions without prior authorization, leading to abnormal traffic patterns, network congestions, and/or inaccurate network capacity planning. For the network carriers, there is a need to balance the bandwidth demand from existing customers in the area with the demand from the FWA devices so as to obtain a stable customer base. This patent document discloses techniques that can be implemented in various embodiments to adapt FWA services for the occasional mobility events associated with the FWA devices. In some cases, the network carriers can use the disclosed techniques to limit the unauthorized movement of the FWA devices. In some cases, the network carriers can use the disclosed techniques offer flexibility in FWA services (e.g., different pricing rates, different network quality levels) that are available to the customers.

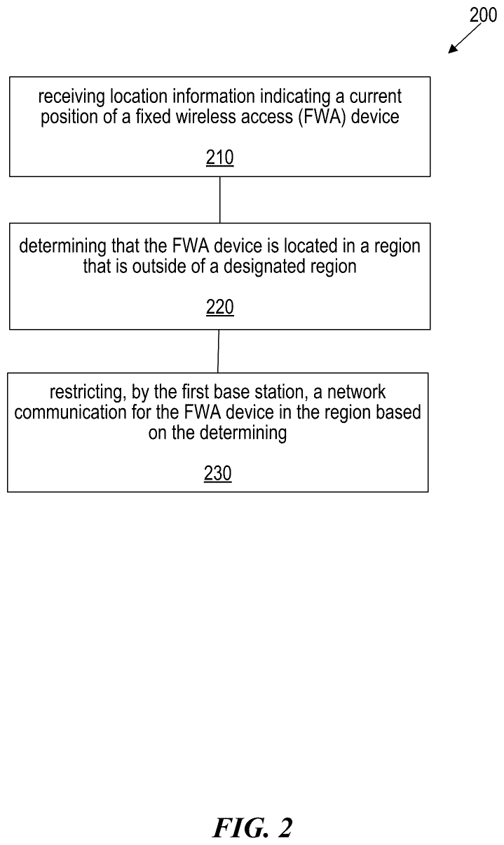

FIG. 2 is a flowchart representation of a process 200 for wireless communication in accordance with one or more embodiments of the present technology. The process 200 includes, at operation 210, receiving, by a first base station, location information indicating a current position of a fixed wireless access (FWA) device. The location information can be Global Positioning System (GPS) information reported by the user devices via the FWA device. The current position of the FWA device can also be determined based on triangulation. The process 200 includes, at operation 220, determining, by the first base station, that the FWA device is located in a region that is outside of a designated region configured for the FWA device based on the current position of the FWA device. The process 200 includes, at operation 230, restricting, by the first base station, a network communication for the FWA device in the region based on the determining.

Restriction of the FWA device can be flexibly provided for different scenarios. In some embodiments, the restricting includes rejecting a network connection request from the FWA device to establish a connection in the region. In some embodiments, the method includes evaluating, by the first base station, a network utilization level in the region, and the restricting includes providing the network communication to the FWA device when the network utilization level is below a threshold (e.g., 50%). In some embodiments, the method includes transmitting, by the first base station, a query to a core network requesting policy information associated with the FWA device, and the restricting includes providing the network communication to the FWA device at a different pricing level or a different network quality level as compared to an original pricing level or an original quality level for operations of the FWA device in the designated region. In some embodiments, the method includes determining, by the first base station, a first bandwidth associated with the designated region and determining, by the first base station, a second bandwidth associated with the region. The restricting includes providing the network communication to the FWA device in the region when the first bandwidth and the second bandwidth satisfy a predefined condition. For example, the FWA device is only allowed to communicate in the region when the second bandwidth is larger than the first bandwidth.

In some embodiments, the designated region of the FWA device is within a coverage area of the first base station. For example, the FWA device moves within the same cell/base station (e.g., intra-cell mobility events). In some embodiments, the designated region of the FWA device is within a coverage area of a second base station. For example, the FWA device moves across different cells/base stations (e.g., inter-cell mobility events).

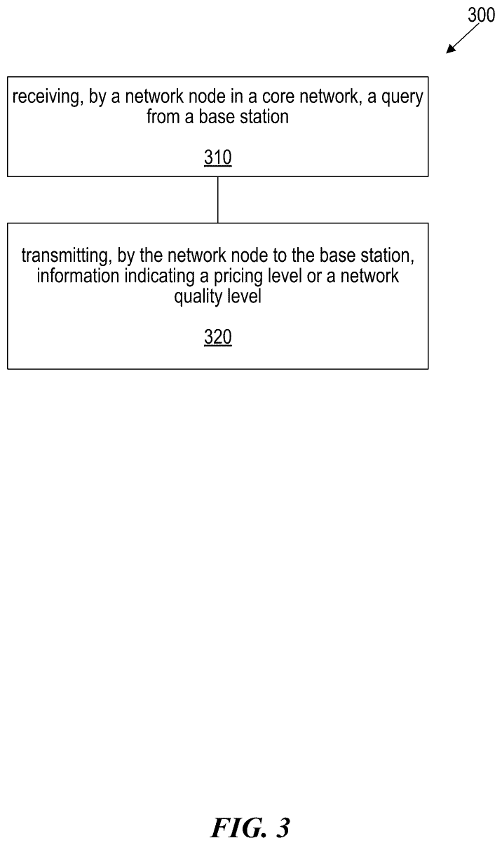

FIG. 3 is a flowchart representation of a process 300 for wireless communication in accordance with one or more embodiments of the present technology. The process 300 includes, at operation 310, receiving, by a network node in a core network, a query from a base station. The query requests information associated with a mobility event of a fixed wireless access (FWA) device. The mobility event occurs upon the FWA device moving from a designated region configured for the FWA device to a different region outside of the designated region. The process 330 also includes, at operation 320, transmitting, by the network node to the base station, information indicating a pricing level or a network quality level associated with the mobility event to the different region so as to enable the FWA device to perform communication in the different region.

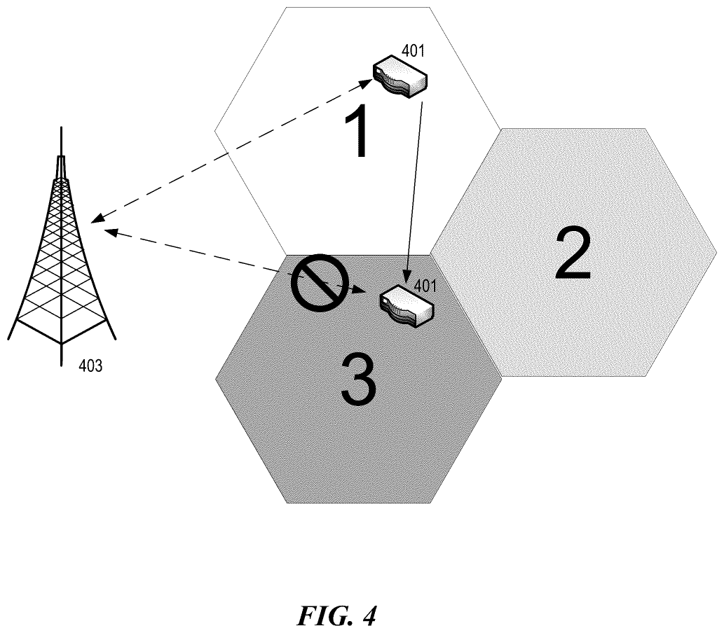

FIG. 4 illustrates an example of intra-cell FWA mobility in accordance with one or more embodiments of the present technology. In this example, each FWA device (e.g., 401) is assigned a specific physical address when it is issued to the user during the registration process. The physical address is associated with a designated area or region (e.g., hex-bin) defined in the network. The size of the designated area or region can be determined by the operator based on the available bandwidth and/or the actual deployment configurations.

During connection establishment or while the FWA device 401 is in the connected state, the FWA device 401 transmits its location information to the base station 303 (e.g., using information such as GPS from the UEs). Based on the location information, the base station 403 identifies that the FWA device 401 is located within its assigned area/region. For example, the FWA device 401 is initially deployed in its designated area Hex-Bin 1. The base station 403 recognizes that the FWA device 401 is correctly located within Hex-Bin1 and provides connection to the FWA device 401 in Hex-Bin1.

The FWA device 401 subsequently moves to a different region/area Hex-Bin 3 and wants to maintain a connection with the base station 403. Based on the location information (e.g., using triangulation and/or GPS data reported by the FWA device and/or the UEs), the base station 303 identifies the current position of the FWA device 401 and determines that the FWA device 401 is no longer within its designated region/area. The base station rejects the connection request from the FWA device 401 to ensure that resources provided to Hex-Bin3 are sufficient for the existing users assigned to Hex-Bin3.

The scenario shown in FIG. 4 can be applicable to rural areas in which larger units of designated areas/regions (e.g., larger hex-bins) are configured for each base station. Lower frequency bands in frequency range FR1 (e.g., band N71 of 30 MHz bandwidth) can be used to offer larger coverage ranges. For example, the radius of the hex-bins in rural areas can be one or two miles (or even larger). In such areas, the usage across different hex-bins is expected to remain relatively stable over time given the low density and the steady number of customers, making dynamic balancing of the workload more difficult for the FWA assets. A “hard” restriction of the FWA services when mobility events occur can be adopted to better accommodate the existing customers in assigned regions.

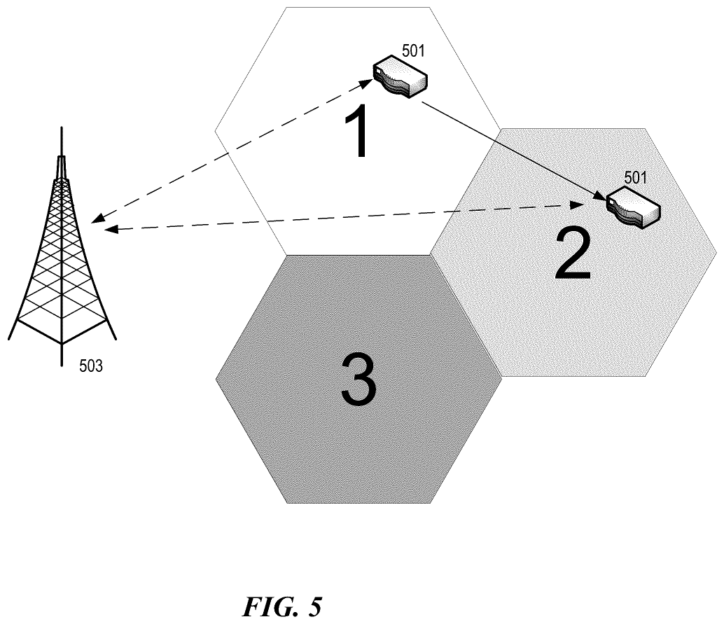

FIG. 5 illustrates an example of intra-cell FWA mobility in accordance with one or more embodiments of the present technology. Each FWA device (e.g., 501) is assigned a specific physical address when it is issued to the user during the registration process. The physical address is associated with a designated area or region (e.g., hex-bin) defined in the network. The size of the designated area or region can be determined by the operator based on the available bandwidth and/or the actual deployment configurations.

During connection establishment or while the FWA device 501 is in the connected state, the FWA device 501 transmits its location information to the base station 503 (e.g., using information such as GPS). Based on the location information, the base station 503 identifies that the FWA device 501 is located within its assigned area/region (e.g., Hex-Bin1) and provides connection to the FWA device 501 in Hex-Bin1.

The FWA device 501 subsequently moves to a different region/area Hex-Bin2 and wants to maintain a connection with the base station 503. Based on the location information (e.g., using triangulation and/or GPS data reported by the FWA device and/or the UEs), the base station 503 identifies the current position of the FWA device 501 and determines that the FWA device 501 is no longer within its designated region/area. Instead of rejecting the connection request immediately, in some embodiments, the base station 503 examines the network utilization of the Hex-Bin2 and determines that it is under-utilized according to a predefined threshold (e.g., 70% utilization). In some embodiments, the base station 503 checks the first bandwidth of Hex-Bin1 and the second bandwidth of Hex-Bin2 and determines whether the first and the second bandwidths satisfy a predetermined condition (e.g., that Hex-Bin2 offers bigger bandwidth as compared to Hex-Bin2). Based on the network utilization level and/or the bandwidths available in different areas/regions, the base station 503 can allow the connection request from the FWA device 501 in Hex-Bin 2. In some embodiments, the base station 503 can make such determination without getting further feedback from the core network.

In some embodiments, different policies and/or pricing levels can be provided for FWA devices that require a certain level of mobility (e.g., the user moves from one address to another). For example, a lower pricing level (e.g., $20 per month plan) can be offered to FWA devices that requires no mobility (e.g., in sparse rural areas). A higher pricing level (e.g., $50 per month plan) can be offered to FWA devices can move across two or three regions (e.g., in dense rural areas or urban settings). FWA devices that require a higher level of mobility (e.g., across more than three regions in dense urban areas) can be charged at a higher pricing level (e.g., $100 per month plan). In some embodiments, the pricing plan can be adaptively changed from a lower tier (e.g., $20 per month) to a higher tier (e.g., $50 per month) upon the occurrence of the mobility event(s).

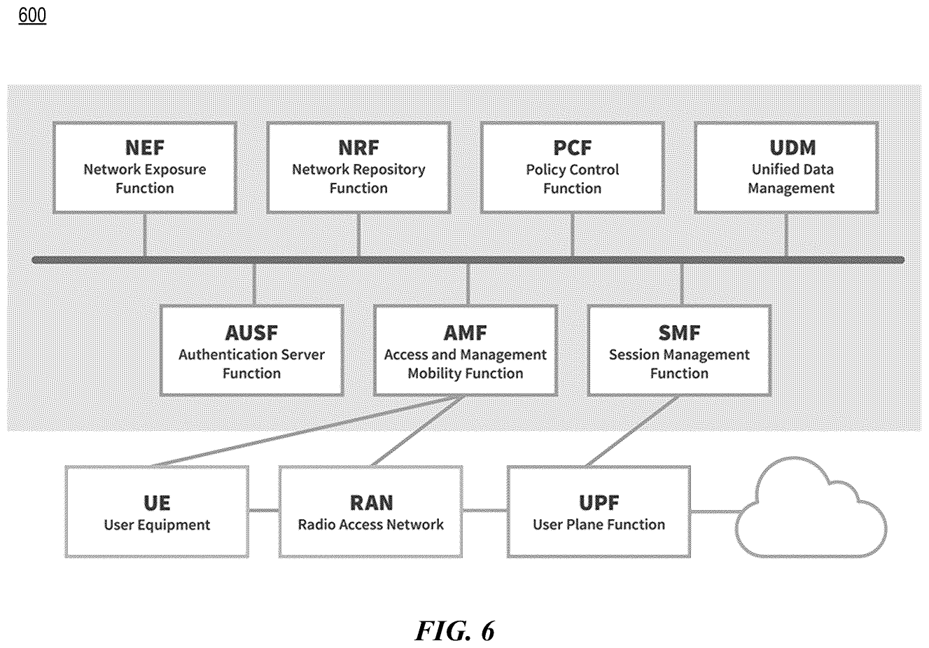

The different pricing levels and policies associated with the FWA devices can be managed by the core network. FIG. 6 illustrates an example core network architecture 600 in accordance with one or more embodiments of the present technology. The base station can query the core network to determine whether the connection request for the new area (e.g., Hex-Bin2) can be allowed. As shown in FIG. 6, the base station (e.g., the radio access network, RAN) can transmit a query to a network node, such as the Policy Control Function (PCF) and/or the Access and Management Mobility Function (AMF), to query the access policies associated with the FWA device. For example, the PCF can provide policy decisions and/or subscription information associated with the FWA device regarding gaining access across different regions. With the information from the core network, the base station can decide whether to reject or allow the connection request. If a connection is allowed and established for the FWA device in the requested area/region, the base station can inform the core network so that appropriate fee(s) can be applied to the user account.

In some embodiments, the base station can adapt the transmission quality for the FWA 501 when it operates outside of its designated area/region. For example, referring back to FIG. 5, a different Quality of Service (QoS) Class Identifier for a 5G QoS Identifier (5QI) can be configured for the FWA device 501 in Hex-Bin2 to ensure that existing authorized users in Hex-Bin2 are not affected by the addition of the FWA device 501 in the region. For example, the FWA device 501 can be configured with 5QI value of 6 in Hex-Bin1, with a default priority level of 60. Upon establishing a connection in Hex-Bin2, the FWA device 501 is configured with 5QI value of 9 with a default priority level of 90. That's, the FWA device 501 is given lower priority as compared to the existing devices in the Hex-Bin2.

As mentioned above, the scenario illustrated in FIG. 5 can be applicable to urban areas in which smaller units of designated areas/regions (e.g., smaller hex-bins) are configured for each base station. Higher frequency bands in frequency range FR2 (e.g., band N258 of 3250 MHz bandwidth) can be used to provide high bandwidth transmissions at a smaller coverage level. For example, the radius of the hex-bins in rural areas can be half a mile (or smaller). The usage across different hex-bins can fluctuate more often due to the dense distribution and increased mobility of the users.

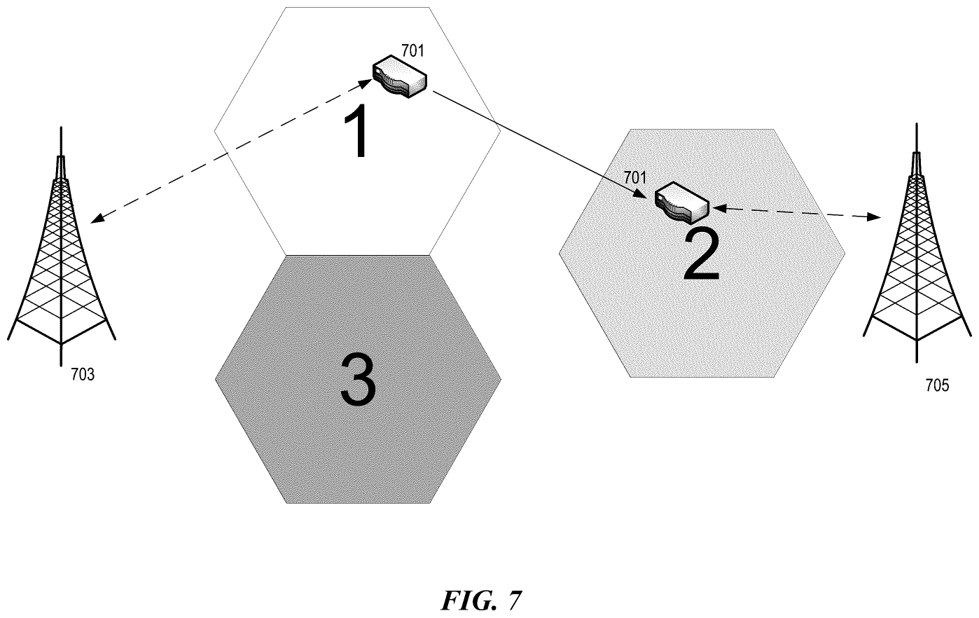

FIG. 7 illustrates an example of inter-cell FWA mobility in accordance with one or more embodiments of the present technology. Each FWA device (e.g., 701) is assigned a specific physical address when it is issued to the user during the registration process. The physical address is associated with a designated area or region (e.g., hex-bin) defined in the network. The size of the designated area or region can be determined by the operator based on the available bandwidth and/or the actual deployment configurations.

During connection establishment or while the FWA device 701 is in the connected state, the FWA device 701 transmits its location information to the base station 703. Based on the location information, the base station 703 identifies that the FWA device 701 is located inside of its assigned area/region and provides connection to the FWA device 701.

The FWA device 701 subsequently moves to a different region/area Hex-Bin2 that is within the coverage area of a different base station 705. The FWA device 701 transmits its location information to the base station 705 in its request to establish a connection with the base statin 705. The base station 705 identifies the current position of the FWA device 701 and determines that the FWA device 701 is no longer within its designated region/area. The base station 705 determine whether network communication of the FWA device in Hex-Bin2 can be enabled based a one or more factors as discussed in Embodiment 2 (e.g., utilization and/or bandwidth available in the region, the pricing level, the quality level, etc.).

Wireless Communications System

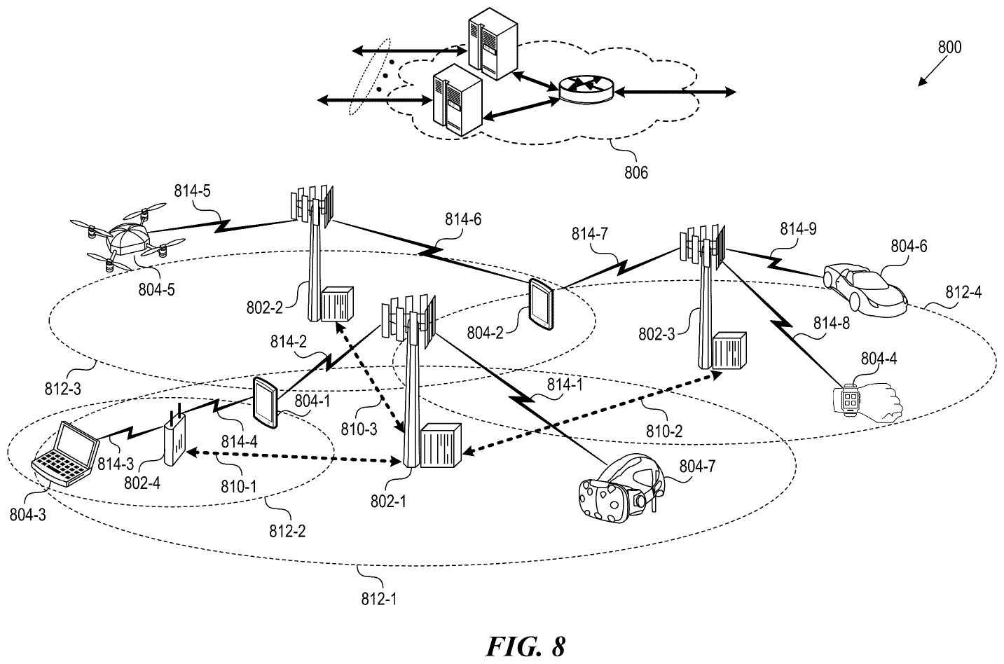

FIG. 8 is a diagram that illustrates a wireless telecommunication network 800 (“network 800”) in which aspects of the disclosed technology are incorporated. The network 800 includes base stations 802-1 through 802-4 (also referred to individually as “base station 802” or collectively as “base stations 802”). A base station is a type of network access node (NAN) that can also be referred to as a cell site, a base transceiver station, or a radio base station. The network 800 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 800 formed by the network 800 also include wireless devices 804-1 through 804-7 (referred to individually as “wireless device 804” or collectively as “wireless devices 804”) and a core network 806. The wireless devices 804-1 through 804-7 can correspond to or include network entities capable of communication using various connectivity standards. For example, a 5G communication channel can use millimeter wave (mmW) access frequencies of 28 GHz or more. In some implementations, the wireless device 804 can operatively couple to a base station 802 over a long-term evolution/long-term evolution-advanced (LTE/LTE-A) communication channel, which is referred to as a 4G communication channel.

The core network 806 provides, manages, and controls security services, user authentication, access authorization, tracking, Internet Protocol (IP) connectivity, and other access, routing, or mobility functions. The base stations 802 interface with the core network 806 through a first set of backhaul links (e.g., S1 interfaces) and can perform radio configuration and scheduling for communication with the wireless devices 804 or can operate under the control of a base station controller (not shown). In some examples, the base stations 802 can communicate with each other, either directly or indirectly (e.g., through the core network 806), over a second set of backhaul links 810-1 through 810-3 (e.g., X1 interfaces), which can be wired or wireless communication links.

The base stations 802 can wirelessly communicate with the wireless devices 804 via one or more base station antennas. The cell sites can provide communication coverage for geographic coverage areas 812-1 through 812-4 (also referred to individually as “coverage area 812” or collectively as “coverage areas 812”). The geographic coverage area 812 for a base station 802 can be divided into sectors making up only a portion of the coverage area (not shown). The network 800 can include base stations of different types (e.g., macro and/or small cell base stations). In some implementations, there can be overlapping geographic coverage areas 812 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 800 can include a 5G network and/or an LTE/LTE-A or other network. In an LTE/LTE-A network, the term eNB is used to describe the base stations 802, and in 5G new radio (NR) networks, the term gNBs is used to describe the base stations 802 that can include mmW communications. The network 800 can thus form a heterogeneous network in which different types of base stations provide coverage for various geographic regions. For example, each base station 802 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 800 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 804 and the base stations 802 or core network 806 supporting radio bearers for the user plane data. At the Physical (PHY) layer, the transport channels are mapped to physical channels.

Wireless devices can be integrated with or embedded in other devices. As illustrated, the wireless devices 804 are distributed throughout the system, where each wireless device 804 can be stationary or mobile. For example, wireless devices can include handheld mobile devices 804-1 and 804-2 (e.g., smartphones, portable hotspots, tablets, etc.); laptops 804-3; wearables 804-4; drones 804-5; vehicles with wireless connectivity 804-6; head-mounted displays with wireless augmented reality/virtual reality (ARNR) connectivity 804-7; portable gaming consoles; wireless routers, gateways, modems, and other fixed-wireless access devices; wirelessly connected sensors that provides data to a remote server over a network; IoT devices such as wirelessly connected smart home appliances, etc.

A wireless device (e.g., wireless devices 804-1, 804-2, 804-3, 804-4, 804-5, 804-6, and 804-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 800 equipment at the edge of a network 800 including macro eNBs/gNBs, small cell eNBs/gNBs, relay base stations, and the like. A wireless device can also communicate with other wireless devices either within or outside the same coverage area of a base station via device-to-device (D2D) communications.

The communication links 814-1 through 814-9 (also referred to individually as “communication link 814” or collectively as “communication links 814”) shown in network 800 include uplink (UL) transmissions from a wireless device 804 to a base station 802, and/or downlink (DL) transmissions from a base station 802 to a wireless device 804. The downlink transmissions can also be called forward link transmissions while the uplink transmissions can also be called reverse link transmissions. Each communication link 814 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 814 can transmit bidirectional communications using frequency division duplex (FDD) (e.g., using paired spectrum resources) or Time division duplex (TDD) operation (e.g., using unpaired spectrum resources). In some implementations, the communication links 814 include LTE and/or mmW communication links.

In some implementations of the network 800, the base stations 802 and/or the wireless devices 804 include multiple antennas for employing antenna diversity schemes to improve communication quality and reliability between base stations 802 and wireless devices 804. Additionally or alternatively, the base stations 802 and/or the wireless devices 804 can employ multiple-input, multiple-output (MIMO) techniques that can take advantage of multi-path environments to transmit multiple spatial layers carrying the same or different coded data.

Computer System

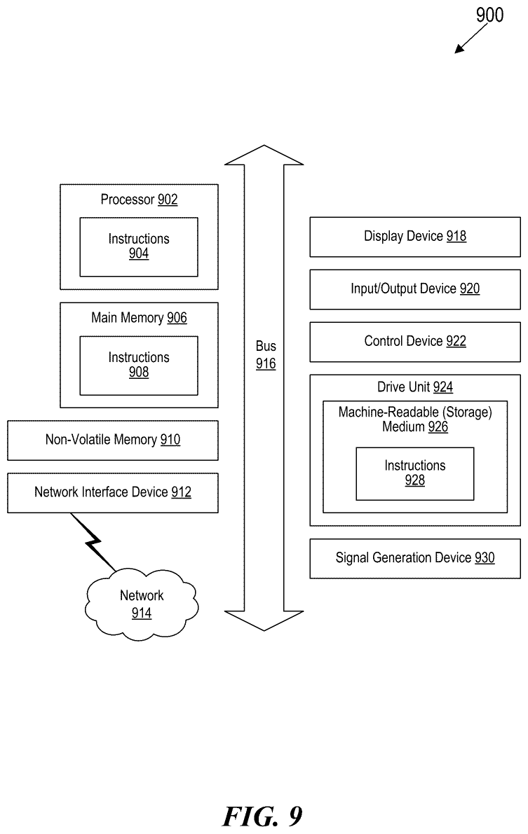

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, video display device 718, an input/output device 920, a control device 922 (e.g., keyboard and pointing device), a drive unit 924 that includes a storage medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computing system 900 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 900. In some implementation, the computer system 900 can be an embedded computer system, a system-on-chip (SOC), a single-board computer system (SBC) or a distributed system such as a mesh of computer systems or include one or more cloud components in one or more networks. Where appropriate, one or more computer systems 900 can perform operations in real-time, near real-time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable (storage) medium 926 can include any medium that is capable of storing, encoding, or carrying a set of instructions for execution by the computing system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computing system 900 to perform operations to execute elements involving the various aspects of the disclosure.

### REMARKS

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

We claim:

1. A method for wireless communication, comprising:
receiving, by a first base station, location information indicating a current position of a fixed wireless access (FWA) device;
determining, by the first base station, that the FWA device is located in a region that is outside of a designated region configured for the FWA device based on the current position of the FWA device; and
based on the determining, restricting, by the first base station, a network communication to/from the FWA device in the region.

2. The method of claim 1, wherein the restricting comprises:
rejecting a network connection request from the FWA device to establish a connection in the region.

3. The method of claim 1, further comprising:
evaluating, by the first base station, a network utilization level in the region, and wherein the restricting comprises:
providing the network communication to the FWA device when the network utilization level is below a threshold.

4. The method of claim 1, further comprising:
transmitting, by the first base station, a query to a core network requesting policy information associated with the FWA device, and wherein the restricting comprises:
providing the network communication to the FWA device at a different pricing level or a different network quality level as compared to an original pricing level or an original quality level for operations of the FWA device in the designated region.

5. The method of claim 1, further comprising:
determining, by the first base station, a first bandwidth associated with the designated region; and
determining, by the first base station, a second bandwidth associated with the region; and wherein the restricting comprises:
providing the network communication to the FWA device in the region when the first bandwidth and the second bandwidth satisfy a predefined condition.

6. The method of claim 1, wherein the designated region of the FWA device is within a coverage area of the first base station.

7. The method of claim 1, wherein the designated region of the FWA device is within a coverage area of a second base station different from the first base station.

8. The method of claim 1, wherein the location information comprises Global Positioning System (GPS) information provided by the FWA device.

9. A method for wireless communication, comprising:
receiving, by a network node in a core network, a query from a base station requesting information associated with a mobility event of a fixed wireless access (FWA) device, wherein the mobility event occurs upon the FWA device moving from a designated region configured for the FWA device to a different region outside of the designated region; and
transmitting, by the network node to the base station, information indicating a pricing level or a network quality level associated with the mobility event to the different region to enable the FWA device to perform wireless communication in the different region.

10. The method of claim 9, wherein the designated region and the different region are represented as hex-bins.

11. The method of claim 9, wherein the network node comprises at least one of an Access and Management Mobility Function (AMF) or a Policy Control Function (PCF).

12. A device for wireless communication, comprising a processor that is configured to:
receive location information indicating a current position of a fixed wireless access (FWA) device;
determine, based on the current position of the FWA device, that the FWA device is located in a region that is outside of a designated region configured for the FWA device; and
restrict a network communication for the FWA device in the region based on the FWA device being in the region that is outside of the designated region.

13. The device of claim 12, wherein the processor is configured to restrict the network communication by:
rejecting a network connection request from the FWA device to establish a connection in the region.

14. The device of claim 12, wherein the processor is configured to:
evaluate a network utilization level in the region, and
restrict the network communication of the FWA device by providing the network communication to the FWA device when the network utilization level is below a threshold.

15. The device of claim 12, wherein the processor is configured to:
transmit a query to a core network requesting policy information associated with the FWA device, and
restrict the network communication of the FWA device by providing the network communication to the FWA at a different pricing level or a different network quality level as compared to an original pricing level or an original quality level for operations of the FWA device in the designated region.

16. The device of claim 12, wherein the processor is configured to:
determine a first bandwidth associated with the designated region;
determine a second bandwidth associated with the region; and
restrict the network communication of the FWA device by providing the network communication to the FWA device when the first bandwidth and the second bandwidth satisfy a predefined condition.

17. The device of claim 12, wherein the designated region of the FWA device is within a coverage area of the device.

18. The device of claim 12, wherein the designated region of the FWA device is within a coverage area of a second base station.

19. The device of claim 12, wherein the processor is configured to determine the region in which the FWA device is located by triangulation.

20. The device of claim 12, wherein the location information comprises Global Positioning System (GPS) information provided by the FWA device.
